(19) United States
(12) Patent Application Publication
(10) Pub. No.: US 2020/0380228 A1
(43) Pub. Date: Dec. 3, 2020

(54) Product Identification Systems and Methods

(71) Applicants: Andrew F. Fireman, North Bethesda, MD (US); Marnie P. Fireman, North Bethesda, MD (US)

(72) Inventors: Andrew F. Fireman, North Bethesda, MD (US); Marnie P. Fireman, North Bethesda, MD (US)

(21) Appl. No.: 16/429,188

(22) Filed: Jun. 3, 2019

(51) Int. Cl. G06K 7/14

(52) U.S. Cl. CPC G06K 7/1443; G06K 2007/10504; G06K 7/1491; G06K 7/1417

(57) ABSTRACT

Systems and devices may be configured to determine one or more optical indicators of a product from image data. The one or more optical indicators may include optically detectable features printed on, attached to, or embedded in the product. A device may process image data to detect one or more of the optical indicators, may determine data from the optical indicator, and may provide information to a device based on the determined information. In one implementation, the information may include product information. In another implementation, the information may include event information associated with a location where the image was captured. In another implementation, the information may include marketing information unrelated to the product.

### FIELD

The present disclosure is generally related to product identification systems and methods, and more particularly, to systems, methods and devices configured to determine information related to a product based on optical indicators.

### BACKGROUND

People regularly see numerous products during the course of their day. For example, a user may see a product on a website while using his or her computer, phone, tablet, or other computing device. People may also see a product while interacting with other people while using a computing device, or in person, or while walking down the street, or while reading a magazine. There are many other ways to see products.

Sometimes, a person may become interested in a product that they see and may want to know more about that specific product. There are numerous things that somebody might want to know about a product that they see and a variety of reasons why he or she may want to know these things. For example, a person may like the product and want to buy it, may be interested in learning more about products of that type, may want to find out what brand the product is, may want to find out about other products made by that brand, may want to find out how that product compares to similar products, may want to find out about complementary products (such as a tie that can match well with a dress shirt), may want to find out about the activity in which a certain product is pictured, and so on. However, the details of the product may be difficult or impracticable to ascertain based on what the person can see.

In some instances, brand labels, printing, and sublimation may serve as product identifiers. However, the details of the product and other information that the person wants to know may be difficult (or impractical, or largely impossible) to ascertain from images.

### SUMMARY

Embodiments of systems, methods, and devices are described below that may receive an image that includes one or more products and that may process the image (or portions of the image or portions of a series of images) to determine the presence of one or more optically detectable indicators. The optically detectable indicators may be attached to, embedded in, printed on, projected on, overlaid or superimposed on, or otherwise transferred onto the products. The optically detectable indicators may include data that can be determined from the optically detectable indicators. In some implementations, the data may be used to retrieve information about a product, which information may be sent to a device or displayed on a display. The display may be a touchscreen display of a computing device (such as a smartphone), digital glasses, or another display device. In some implementations, the data may be used to retrieve information about the image (such as brand information, context information, information about the person wearing or using the product, information about the most common uses for the product, and so on), information about an event, or other information. In still other implementations, the data may include or be used to retrieve information about other products. For example, the data may include or may be used to retrieve information about similar products available from the same brand, complementary products from the same brand, complementary products from other brands, similar products from other brands, services related to the product, services related to the context of the product within the image data, or any combination thereof. Other implementations are also possible.

In some embodiments, a product may include a brand logo, which may include one or more optical indicators. In some implementations, an optical indicator may be imperceptible to an individual with 20/20 vision, but may be detectable to a camera of a computing device, such as a commercially available smartphone. The optical indicator may include subtle color contrasts defining a computer-readable pattern encoding the data that can be decoded by the computing device. In an example, the computer-readable pattern may include a barcode, a multi-layer code (such as a Quick Response (QR) code), text, another pattern, or any combination thereof. Other computer-readable patterns are also possible.

A device may process image data to determine one or more products within an image, may process at least a portion of the image data that is associated with the one or more products to identify one or more optical indicators, and may determine data from the one or more optical indicators. In one possible implementation, the device may use the data to determine information about the product, about a context associated with the image, other information, and so on. The device may provide the determined information to a display. Other implementations are also possible.

In one possible implementation, a manufacturer may produce a product that includes one or more optical indicators. The optical indicators may include data associated with the product. The data may include lookup information that may direct a computing device to visit a uniform resource location (URL) and to provide a particular code, which may cause the computing device to be directed to particular information. Over time, the particular information may be changed to present selected information to a potential consumer. In one example, the data may include lookup information that may direct a computing device to visit a URL, which may provide information about the product, information about other products, information about the context of the image, or even information about products of competitors or of other manufacturers. In some implementations, the information may include information about complementary products of the same brand, complementary products from other sources, other products, information comparing products (e.g., comparing a product of a first brand to products of other brands), and so on. In one possible implementation, the information may include a recommendation indicating why the consumer ought to buy one product as compared to another product. Other implementations are also possible.

For example, at a first time, a user may utilize a computing device to view a particular image. The user may access a particular application to view the image, and the device may use the application to process the image to determine the optical indicators, may determine data from the optical indicators, may determine information based on the determined data, and may provide the information to a display. In lieu of or in addition to providing the information to the display, the computing device may deliver the information via a speaker. Other implementations are also possible. At a second time, the user may again view the same image using the application, which may process the image to determine the optical indicators, determine data from the optical indicators, and determine second information based on the determined data. The device may provide the second information to the display (to a speaker, or both). In this example, the information provided in response to the data determined from the optical indicators may change over time.

In some implementations, a product may include multiple optical indicators including a first optical indicator including first data and including a second optical indicator including second data. The second data may be different from the first data. For example, the first optical indicator may provide brand data, and the second optical indicator may provide data related to a complementary product.

In some implementations, systems and devices may be configured to determine one or more optical indicators of a product from image data. The one or more optical indicators may include optically detectable features printed on, attached to, transferred onto, or embedded in the product. A device may process image data to detect one or more of the optical indicators, may determine data from the optical indicator, and may provide information to a device based on the determined information.

In one implementation, the information may include product information, an introduction to the brand associated with a product or another brand, complementary product information, other information, or any combination thereof. In some implementations, the information may include an offer of an incentive (perhaps a discount) for purchasing additional items from the brand or for referring friends to the brand. In another implementation, the information may include an offer of an incentive for the consumer to answer questions regarding a product or brand, the consumer's interest in the product or the brand, the consumer's interest in other products or brands, or any combination thereof. In another implementation, the information may include event information associated with a location where the image was captured, information associated with the activity with which the product was depicted or with which the product may be used, and so on. In another implementation, the information may include marketing information about products and services, which may be unrelated to the product or which may be related only in the sense that the person identifying the product likely has an interest in other things. In still another implementation, the information may include complementary items that are available from the same brand or complementary items that are available from other brands. In still another implementation, the information may include information about competitive items along with a comparison showing why a first product is superior to the competitive items. In yet another implementation, the information may include information regarding the product in different colors or materials. For example, the information may include information about a polo shirt that is available in the same style but in one or more other colors. Other implementations are also possible.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a block diagram of a system to provide information in response to optical indicators within an image, in accordance with embodiments of the present disclosure.

FIG. 2 depicts a block diagram of a system to provide information in response to optical indicators within an image, in accordance with embodiments of the present disclosure.

FIG. 3 depicts a flow diagram of a method of determining product information related to an optical indicator and providing the information to a third party, in accordance with embodiments of the present disclosure.

FIG. 4 depicts a flow diagram of method of capturing image data including optical indicators, in accordance with embodiments of the present disclosure.

FIG. 5 depicts various products, each of which may include one or more optical indicators, in accordance with embodiments of the present disclosure.

FIG. 6 depicts various products, each of which may include one or more optical indicators, in accordance with embodiments of the present disclosure.

FIG. 7 depicts various products, each of which may include one or more optical indicators, in accordance with embodiments of the present disclosure.

FIG. 8 depicts various products, each of which may include one or more optical elements, in accordance with embodiments of the present disclosure.

FIG. 9 depicts a diagram showing one possible example of an optical indicator, in accordance with embodiments of the present disclosure.

FIG. 10 depicts a diagram showing another possible example of an optical indicator, in accordance with embodiments of the present disclosure.

FIG. 11 depicts a block diagram of a computing device that may be part of the systems of FIGS. 1 and 2, in accordance with embodiments of the present disclosure.

FIG. 12 depicts a server that may be part of the systems of FIGS. 1 and 2, in accordance with embodiments of the present disclosure.

FIG. 13 depicts a diagram of a graphical interface that may be displayed on a computing device, in accordance with embodiments of the present disclosure.

FIG. 14 depicts a diagram of a graphical interface that may be displayed on a computing device, in accordance with embodiments of the present disclosure.

FIG. 15 depicts a flow diagram of a method of determining information based on optical indicators, in accordance with embodiments of the present disclosure.

FIG. 16 depicts a flow diagram of a method of providing information based on optical indicators, in accordance with embodiments of the present disclosure.

While implementations are described in this disclosure by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used in this disclosure are for organizational purposes only and are not meant to be used to limit the scope of the description or the claims. As used throughout this application, the word “may” is used in a permissive sense (i.e., meaning having the potential to) rather than the mandatory sense (i.e., meaning must). Similarly, the words “include”, “including”, and “includes” mean “including, but not limited to”.

### DETAILED DESCRIPTION OF ILLUSTRATIVE EMBODIMENTS

Embodiments of systems, methods, and devices described below enable usage of space on a product to provide information to a consumer. The product may include one or more optical indicators. The optical indicators may include data that is imperceptible to a person having 20/20 vision, but that can be detected optically by a computing device. In some instances, the optical indicators may be too small to be visible with the naked eye. In other instances, the optical indicators may include a pattern formed using subtle color contrasts that may be virtually invisible to a person having 20/20 vision, but that may be detectable by a computing device. In still other instances, the optical indicators may be too small and too subtle for a person having 20/20 vision to see. In this instance, the optical indicators may include a combination of small size and subtle color contrasts that may be virtually invisible to a person having 20/20 vision.

In some implementations, the optical indicators may include data, such as a uniform resource locator (URL), product information, brand information, information about other products, information about complementary products, information about competitive products, other information, or any combination thereof. A computing device may extract the data and may use the data to determine information, which may be presented to a display, to a speaker, or both. Other implementations are also possible.

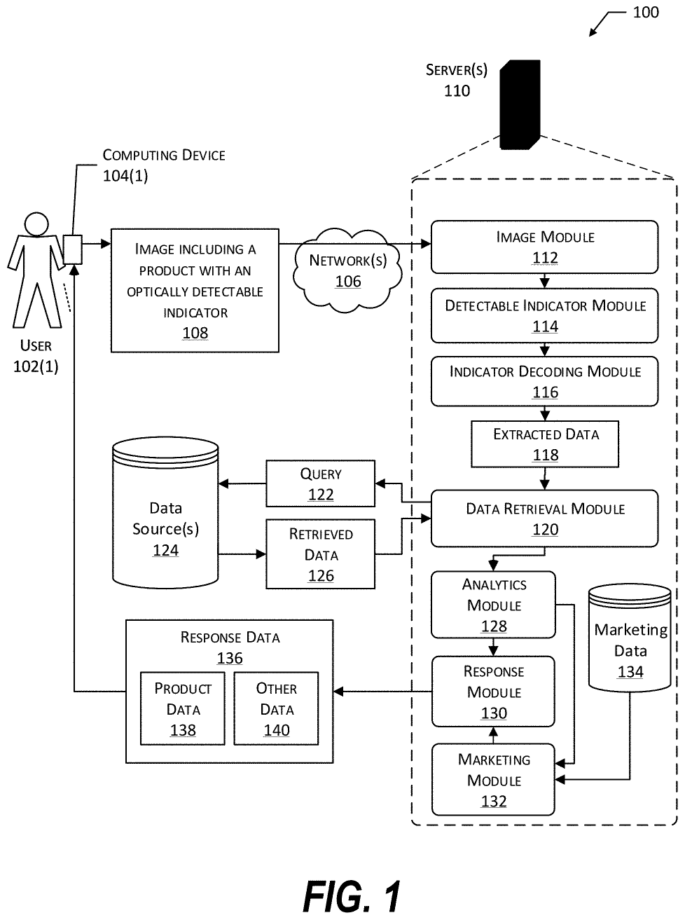

FIG. 1 depicts a block diagram of a system 100 to provide information in response to optical indicators within an image, in accordance with embodiments of the present disclosure. The system 100 may include a computing device 104 to communicate with one or more servers 110 via a network 106. The network 106 may include the Internet, one or more other networks, or any combination thereof.

A user 102 may utilize the computing device 104 to send an image including a product with an optically identifiable indicator 108 to the one or more servers 110 via the network 106. The image may be downloaded from a website, received from another source, or captured by a camera of the computing device 104 in person, from a display, from a magazine, from a billboard, or from another source. The optically identifiable indicator may have a size attribute, a contrast attribute, or a combination thereof, that renders the optically identifiable object invisible to the unaided eye of a user with 20/20 vision but that can be visible to a computing device 104. For example, the size attribute may correspond a size that is as small as a fraction of a millimeter. The contrast attribute may be a color contrast between colors that define a computer-readable pattern and surrounding colors, which may be small enough to be undetectable to the unaided eye of a user with 20/20 vision but that can be visible to a computing device 104. The pattern may define a computer-readable font or pattern, which can embed information that can be used by the computing device 104 or by the one or more servers 110 to determine information about a product, a service, a brand, an event, or other information.

The one or more servers 110 may include an image module 112 to receive the image including the product with an optically detectable indicator 108. The image module 112 may be configured to process the image data to determine one or more portions of the image data for further processing. In one possible example, the image module 112 may determine boundaries or edges of one or more products within the image, for example, based on contrast within the image data.

The one or more servers 110 may further include a detectable indicator module 114 to receive the image data or the one or more portions of the image data and to determine the presence of one or more optical indicators within the image data. The detectable indicator module 114 may determine the one or more optical indicators on the product. The optical indicators may include patterns, text, codes (such as barcodes, QR codes, or other symbols), other information, or any combination thereof. In some implementations, the optical indicators may be invisible to a person who has 20/20 vision, but may be visible to the optical sensors. For example, the optical indicator may be too small to be seen with the naked eye but may be captured within the image data and processed digitally to recover the information. In another example, the optical indicator may include one or more color variations that have a color contrast that cannot be seen by a person who has 20/20 vision, but which may be optically detectable from the image data. In yet another example, the optical indicator may include a pattern etched on, printed on, transferred on, or embedded within or on a fastener (such as a snap, a button, a zipper, a fastener, or any combination thereof).

In the event that the detectable indicator module 114 does not determine the presence of an optical indicator, the one or more servers 110 may send response data 136 to the computing device 104 indicating that the product cannot be identified from the image data. In one possible implementation, the response data 136 may invite the user 102 to provide additional images, one of which may include an optical indicator. Other implementations are also possible.

The one or more servers 110 may include an indicator decoding module 116 that may process the optical indicators to determine data. In an example, the optical indicator may include a barcode or QR code, and the indicator decoding module 116 may extract data from the barcode or QR code. In another example, the optical indicator may include a pattern that can be discerned from the optical data and the indicator decoding module 116 may determine information from the pattern. The indicator decoding module 116 may provide extracted data 118 (data determined from the optical indicator) to a data retrieval module 120.

The data retrieval module 120 may generate one or more queries 122 based on the extracted data 118 and may use the query 122 to retrieve data from one or more data sources 124. The one or more data sources 124 may include websites, databases, and other data sources. Some of the one or more data sources may be associated with the one or more servers 110, while others of the one or more data sources may be associated with third parties.

The data retrieval module 120 may send the query 122 to one or more data sources 124 and may receive data in response thereto. The retrieved data 126 may be received by the data retrieval module 120. In one example, the query 122 may be generated from the extracted data 118. In some implementations, the extracted data 118 may include URL data and optionally a code. The retrieved data 126 may include data related to the query 122. In one possible example, the retrieved data may include product information, such as information about a product within the image, information about a different product, other information, or any combination thereof. In another example, the retrieved data 126 may include information about an event, information about a context of the image, other information, or any combination thereof.

The data retrieval module 120 may provide the retrieved data 126 to an analytics module 128 together with the image including the product with the optically detectable indicator 108 and optionally historical information about the user 102, the computing device 104, an account associated with the user 102 or the computing device 104, other data, or any combination thereof. The analytics module 128 may process the received data to determine one or more attributes of the user 102, the product, the brand, other data, or any combination thereof based on the extracted data 118 and the retrieved data 126. In some implementations, the analytics module 128 may be configured to process the image data to determine context information from the image data. The context information may include background details, content details, and so on, which may be indicative of an interest of a user 102. In some implementations, the analytics module 128 may utilize machine learning, which may be trained with a training set to determine context data associated with an image, such as a “family” context, a “friends” context, an “athletic event” context, an “adventure” context, and so on. There are numerous possibilities for what context information can be presented to the user 102. This context information can be used to determine information that may be of interest for presentation to the user 102. The analytics module 128 may provide data to the response module 130 and optionally to a marketing module 132.

The one or more servers 110 may further include a response module 130, which may receive attribute data, extracted data 118, and retrieved data 126 from the analytics module 128 and which may receive marketing information from a marketing module 132. The marketing module 132 may retrieve the marketing information from a marketing data database 134 and may provide the marketing information to the response module 130. For example, the marketing information may include complementary product information, suggestions, comparative reviews, incentives (such as discounts), other information, or any combination thereof, at least some of which may be of interest to the user 102. In another example, the marketing information may include competitive product information and may also include a comparison of the product including its features and benefits as compared to those of other products.

In some implementations, the marketing module 132 may determine products, services, or other information that may be of interest to the user 102 and may provide the information to the response module 130 to be sent to the device 104 associated with the user 102. For example, the marketing module 132 may cause the response module 130 to push information to the computing device 104. Other implementations are also possible.

The response module 130 may generate response data 136 based on the attribute data, the extracted data 118, the retrieved data 126, and marketing data from the marketing module 132. For example, the response module 130 may generate response data 136 including product data 138 and other data 142 and may provide the response data 138 to the computing device 104. The response data 136 may include product information, complementary product information, information about services, information about events, discount codes, coupon codes, other information, and so on.

In one possible example, a user 102 may capture a picture of an object using a camera of a computing device 104, such as a smartphone. The object may be a shirt worn by an athlete during a competition. The picture may be captured live, from a magazine, or from a television or other display. The user 102 may interact with the computing device 104 to send the image including a product with an optically identifiable indicator 108 to the one or more servers 110 through the network 106. The optically identifiable indicator 108 may be attached to, printed on, transferred onto, or embedded in the product. In one possible implementation, the optically identifiable indicator 108 may be attached to a product by overlaying the optically identifiable indicator 108 onto the product, for example, using augmented reality or by projecting the optically identifiable indicator 108 onto the product.

In response to receiving the image, the one or more servers 110 may process the image data to determine the one or more optical indicators and to determine data from the optical indicators. The one or more servers 110 may retrieve information related to the determined data. In one possible example, the retrieved information may include data about the product, data about the context of the image, marketing data related to (or unrelated to) the product, data related to services corresponding to the product, data about activities related to the product, other data, or any combination thereof.

For example, a manufacturer may sell advertising space on a product, such that the one or more servers 110 may determine the marketing information and may provide the response data 136 including the marketing information, such as a different shirt, a pair of pants, information about an event where the athlete depicted in the photo may be competing, information about the sport in which the athlete competes, information about services related to the sport, and so on. It should be appreciated that sports and sports competition or related services is just an example and is not intended to be limiting. In an alternative example, an image may include an actor on a stage, and the response data 136 may include event information associated with a play, information about the actor, information about other performances, and so on. Other implementations are also possible. The one or more servers 110 may provide the marketing information as part of the response data 136 to the computing device 104.

In another example, the manufacturer may include information in the optically detectable indicator that can be used to retrieve information about the product. The information included in the optically detectable indicator may include the size, universal product code (UPC), a stock keeping unit (SKU) code, other data, or any combination thereof associated with the product. The one or more servers 110 may provide response data 136 including the product data 138 and other data 140 to the computing device 104. Other implementations are also possible.

In another example, the one or more servers 110 may determine an interest or possible interest of the user 102 based on the image including the product with the optically detectable indicator 108, based on historical data, based on information provided by the user 102 (such as responses to survey questions), based on other information, or any combination thereof. In one possible example, interest of the user 102 may be determined analyzing the products about which the user 102 has sought more information. In an example, such products may or may not include optical indicators, but the one or more servers 110 may still capture information from the image data. Over time and based on more and more requests for information about products, the one or more servers 110 may be able to more accurately determine the user's interest or interests.

Based on the determined interests of the user 102, the one or more servers 110 may provide response data 136 including one or more recommended items or events. For example, the one or more servers 110 may determine that the user is interested in sporting events based on the image data and may present an opportunity as part of the response data 136 that includes a ticket purchase option to a similar sporting event, or other option. Other implementations are also possible.

In some implementations, the analytics module 128 of the one or more servers 110 may determine or infer interests of the user 102 over time. Each time that the user 102 submits image data to the one or more servers 110, the analytics module 128 determines information about the interests of the user 102. The one or more servers 110 may utilize the determined information to suggest other items in which the user might be interested. In one possible example, the one or more servers 110 may provide response data 136 to the computing device 104 associated with a user 102 including a suggestion such as “If you liked that product, you may also like this product.” In another example, the response data 136 may recommend a service to the user. For example, the response data 136 may include a suggestion such as “If you liked that product, you might find this service of interest.” Other implementations are also possible.

In some implementations, the analytics module 128 may determine a count of a number of images of a sequence of images of a product provided by the device 104 associated with a particular user 102. When the count meets or exceeds a count threshold, the analytics module 128 may provide an indicator to the marketing module 132 to trigger the marketing module 132 to include a discount code or coupon code to the user 102 within the response data 136. Other implementations are also possible.

In one possible example, the image may include a product and background location data, which may include an optical indicator related to a service. For example, a picture may include a mountain bike under repair in a bike repair shop. The image of the mountain bike may include a first optical indicator including data about the mountain bike and the background repair shop portion may include a second optical indicator including data about the repair shop, repair services offered by the shop, a technician shown in the picture, or any combination thereof. For example, the response data 136 may include an image of a mountain bike being expertly serviced in a repair shop. The computing device 104 may present the image within a graphical interface, and the user 102 may specify which product or portion of the image that he or she is interested in, by selecting the portion of the image (such as by touching the product or the background). By selecting the background, the user 102 is indicating that he or she is interested in information about the repair shop. In some implementations, optical indictors may be presented on the portion associated with the shop, on the technician, on the bike, and so on. In response to receiving the image and data related to the selection by the user 102, the one or more servers 110 may determine an optical indicator corresponding to the user's selection, may determine data related to the optical indicator, and may provide response data 136 including information corresponding to the repair services.

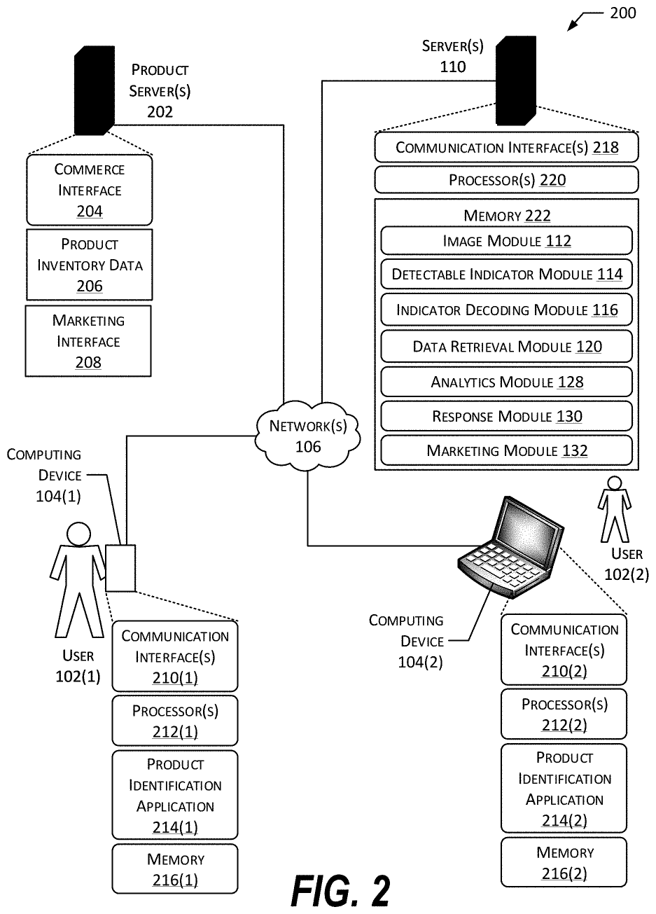

It should be appreciated that the one or more servers 110 may be accessed by one or more computing devices 104, such as a smartphone, a laptop computer, a tablet computer, a desktop computer, another computing device, or any combination thereof. Further, the computing devices 104 may include processor-readable instructions that cause the processor to perform various operations. One possible example of the system 100 is described below with respect to FIG. 2, which depicts different computing devices 104 interacting with the one or more servers 110.

FIG. 2 depicts a block diagram of a system 200 to provide information in response to optical indicators within an image, in accordance with embodiments of the present disclosure. The system 200 may be an embodiment of the system 100 of FIG. 1. In the illustrated example, the user 102(1) may utilize a computing device 104(1) to communicate with one or more severs 110 through a network 106. Further, the user 102(1) may utilize the computing device 104(1) to communicate with one or more product servers 202. A second user 102(2) may utilize a second computing device 104(2) to communicate with the one or more servers 110 and optionally with the product servers 202 via the network 106.

In some implementations, the product server 204 may include a commerce interface 204, which may present a web page with commercially available products to internet browser applications. The product servers 202 may also include product inventory data 206, which may include available products that can be purchased via the commerce interface 204. Further, the product servers 202 may include a marketing interface 208 through which one or more users may interact to enter promotional information and optionally to push data to one or more users, for example, based on interest data.

The computing device 104 may include one or more communication interfaces 210, which may include input/output interfaces that may communicate with input/output devices, such as keypads, keyboards, pointer devices, display devices, touchscreen devices, printers, and so on. The communication interfaces 210 may also include network interfaces, which may include wireless transceivers, wired transceivers, RJ-45 connectors, other interfaces, or any combination thereof. The communication interfaces 210 may communicate with the network 106. Other implementations are also possible.

The computing device 104 may include one or more processors 212, which may execute instructions that may cause the processor 212 to perform various functions. The computing device 104 may also include a product identification application 214, which may capture image data and provide the image data to the one or more servers 110. In some implementations, the product identification application 214 may include an Internet browser application rendering a webpage or including a plugin that communicates the image data to the one or more servers 110. The computing device 104 may further include a memory 216 to store data and to store processor-readable instructions. It should be appreciated that the computing device 104 may include a portable computing device, such as a smartphone, a tablet computer, a laptop computer, another computing device, or any combination thereof.

The one or more servers 110 may include one or more communication interfaces 218. The communication interfaces 218 may include one or more network interfaces to communicate with one or more computing devices 104 and one or more other servers, such as the product servers 202, via the network 106. The server 110 may further include one or more processors 220, which may execute instructions to perform various operations.

The one or more servers 110 may further include a memory 222, which may store data and processor-readable instructions. The memory 222 may include the image module 114, the detectable indicator module 114, and the indicator decoding module 120. The memory 222 may further include the data retrieval module 120, the analytics module 128, the response module 130, and the marketing module 132. The one or more servers 110 may operate as described above with respect to FIG. 1.

In some implementations, a user 102(1) may take a picture using a camera of the computing device 104(1) and may provide the picture (image data) to the product identification application 214(1). In one possible implementation, the computing device 104(1) may process the image data to detect one or more optical indicators within the image data and may decode the image data to determine data associated with the optical indicators. The computing device 104(1) may then send a query to the one or more servers 110 or to the product servers 202 based on the determined data. The computing device 104(1) may receive response data 136 in response to the query (either from the one or more servers 110 or from one or more of the product servers 202). The response data 136 may include product information, brand information, information regarding complementary products, information regarding competitive products, information about a specific event or series of events or information regarding the context of the image data, other data, or any combination thereof.

In one possible example, a user 102(1) may take a picture using a camera of the computing device 104(1) and may provide the picture (image data) to the product identification application 214(1). The image data may include two different two polo shirts, each of which may include one or more optically detectable indicators. In one possible example, the product identification application 214 may provide a selectable option accessible by a user to identify which of the products the user 102 is interested in, such as by selecting the particular polo shirt.

In another possible example, the computing device 104(1) may send the image data to the one or more servers 110, which may detect one or more first optical indicators associated with a first polo shirt in the image and one or more second optical indicators associated with a second polo shirt in the image. The one or more servers 110 may determine first data from the one or more first optical indicators and may determine second data from the one or more second optical indicators. The one or more servers 110 may determine first information based on the first data and second information based on the second data. The one or more servers 110 may then provide the response data 136 including the first information and the second information to the computing device 104(1). The response data 136 may be included within a graphical interface provided to a display of the computing device 104(1). The graphical interface may include a first selectable option to access the first information associated with the first polo shirt and a second selectable option to access the second information associated with the second polo shirt. In one possible example, the first selectable option may include a visual outline of the first polo shirt and the second selectable option may include a visual outline of the second polo shirt. The user 102(1) may select one of the polo shirts by touching the image or a button in the graphical interface or by otherwise selecting the item, such as with a stylus, a pull-down menu, a radio button, and so on.

In another implementation, the computing device 104(1) may provide the image data or the optical indicators to the one or more servers 110, which may process the optical indicators to determine data. The one or more servers 110 may use the determined data to generate response data 136, which may be provided to the computing device 104(1).

In another example, a user 102(2) may use the computing device 104(2) to upload an image to the product identification application 214(2). The product identification application 214(2) may process the image data to determine whether any optical indicators are present, to identify or extract the optical indicators, and may decode the optical indicators to determine data. The computing device 104(2) may use the product identification application 214(2) to retrieve information related to the determined data and may provide the retrieved information to a display. Alternatively, the product identification application 214(2) may provide the image data, the optical indicators, the determined data, or any combination thereof to the one or more servers 110. In response, the one or more servers 110 may process the received data and may provide the response data 136 to the computing device 104(2), which may display the response data 136. Other implementations are also possible.

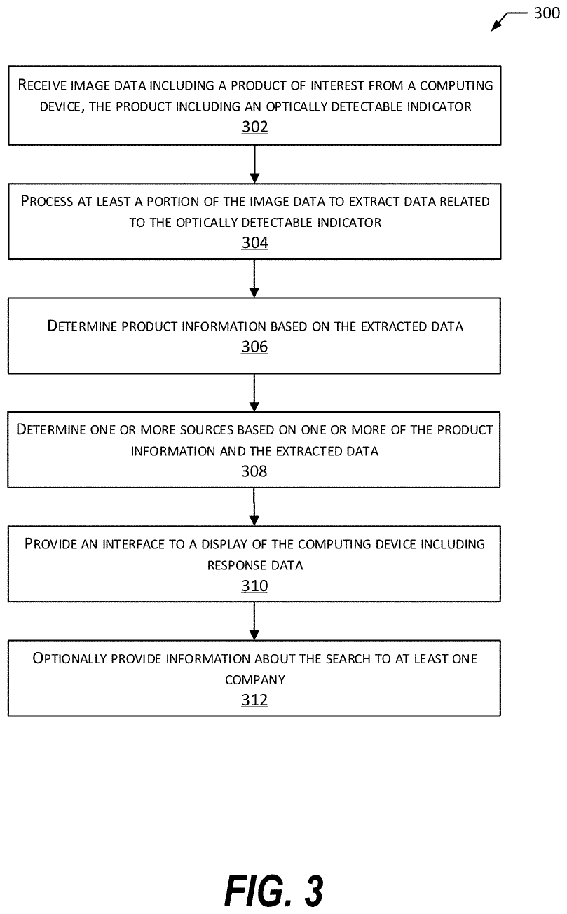

FIG. 3 depicts a flow diagram of a method 300 of determining product information related to an optical indicator and providing the information to a third party, in accordance with embodiments of the present disclosure. At 302, image data including a product of interest is received from a computing device 104, where the product includes an optically detectable indicator. For example, the image data may be captured by a camera of the computing device 104 or may be uploaded from a website (such as Pinterest, Instagram, Snapchat, Facebook, other cites, or another site) or other source to the one or more servers 110.

At 304, at least a portion of the image data is processed to extract data related to the optically detectable indicator. For example, the optically detectable indicators may be positioned in pre-determined locations on the product. In one possible example, at least one of the optically detectable indicators may be provided as part of a fastener, snap, or button of the product, such that the portion of the image data that includes the fastener may be processed. In other implementations, the detectable indicator module 114 of the one or more servers 110 may process the image data to identify optical indicators within the image data. Other implementations are also possible.

At 306, product information is determined based on the extracted data. The product information may include information about the product of interest, information about a context in which the product of interest was captured (such as an action photograph related to an event or activity), other information, or any combination thereof. In one example, the extracted data may include a description of the product. In another example, the extracted data may include URL data, UPC data, SKU data, other data, or any combination thereof. In still another example, the extracted data may include information about a related product, information about a complementary product, information about a competitive product, information about an event, an offer related to another product or event, information about a service related to the product, information about a service unrelated to the product but that the user is likely to have an interest in based on his or her product inquiries, other data, or any combination thereof.

At 308, one or more sources are determined based on one or more of the product information and the extracted data. For example, one or more sources from which the product of interest may be purchased can be determined based on the product information. In another example, one or more sources may be determined from which related information may be retrieved. In still another example, one or more sources from which the product may be purchased can be determined based on proximity to the current location of the user 102, based on lowest price, based on shortest delivery time, based on other factors, or any combination thereof. Other implementations are also possible.

At 310, an interface is provided to a display of the computing device that includes response data. For example, the response data can include information about a product within the image, information about another product, information about the brand, information about an event, information about the context of the product, and so on.

At 312, information about the search may be optionally provided to at least one company. For example, the product information may be provided to a company, such as a marketing company, a retailer or a manufacturer of the product, so that the company could present an offer to the user or provide information to the user 102 that may be of interest to the user 102. Other implementations are also possible.

In one possible example, a company may want to generate user interest in its brand. The company may have a great, authentic, and interesting story. The company may or may not want to offer the user 102 discounts on other products at that time. Perhaps as part of providing the information, the company may obtain the email address, text address, Instagram address, or other address of the user 102. The company may choose to educate the user 102 before trying to sell anything. Other implementations are also possible. The one or more servers 110 may provide brand information to the computing device 104, for example, based on a determined interest of a user 102 associated with the computing device 104.

In another possible example, the product identification application 214, the response data 136, or both may be configured to direct a user 102 to a particular website where used, “new with tags”, or other items are being sold. The site may or may not sell items that are new from the manufacturer or from a retailer. In one possible example, the response data 136 may direct the user to an auction website, such as eBay. Other implementations are also possible.

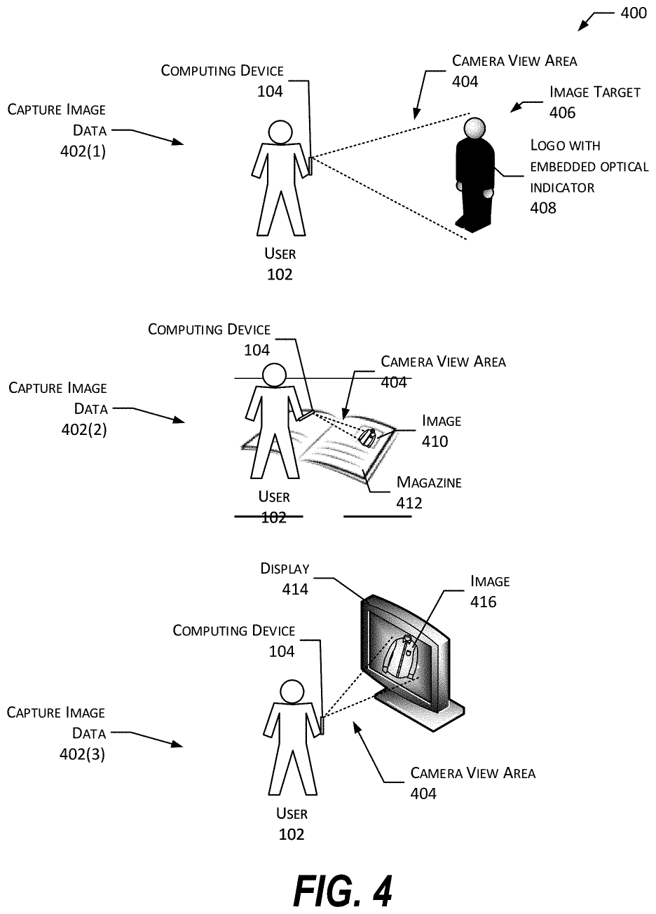

FIG. 4 depicts a flow diagram of method 400 of capturing image data including optical indicators, in accordance with embodiments of the present disclosure. At 402(1), a user 102 may utilize a computing device 104 to capture an image of an image target 406 within a view area 404 of a camera of the computing device 104. The image target 406 may be wearing a garment including a logo with an embedded optical indicator 408. Alternatively, the image target 406 may be at a location that includes one or more optical indicators 408. In another example, the image target 406 may be using or otherwise interacting with a product that includes one or more optical indicators. In some implementations, the image target 406 may include an activity corresponding to a service that is associated with the one or more optical indicators. Other implementations are also possible.

In one possible example, the logo may identify a brand associated with the garment (or product or service). Within the logo, one or more optically detectable indicators may be included, which can be detected from the image data. Other implementations are also possible.

At 402(2), a user 102 may use the computing device 104 to capture an image of an image 410 from a magazine 412 (or other printed publication) by directing a camera of the computing device 104 toward the magazine 412. The computing device 104 may capture an image of the image 412 that is within the view area. The image 412 may include one or more optical indicators.

In still another example, at 402(3), the user 102 may utilize the computing device 104 to capture a picture of an image 416 on a display 414. The image 416 may include one or more optical indicators. Other implementations are also possible.

While the example at 402(1) depicts the optical indicator as being part of the logo, it should be understood that the optical indictor may be included in a variety of locations on the product and may have a variety of different implementations. In some implementations, the optical indicator may not be associated with the logo. For example, the optical indicator may be included in or on fasteners (snaps or buttons) or on handles of a product. In another example, the optical indicator may be woven into, printed on, transferred onto, or attached to a product. Other implementations are also possible.

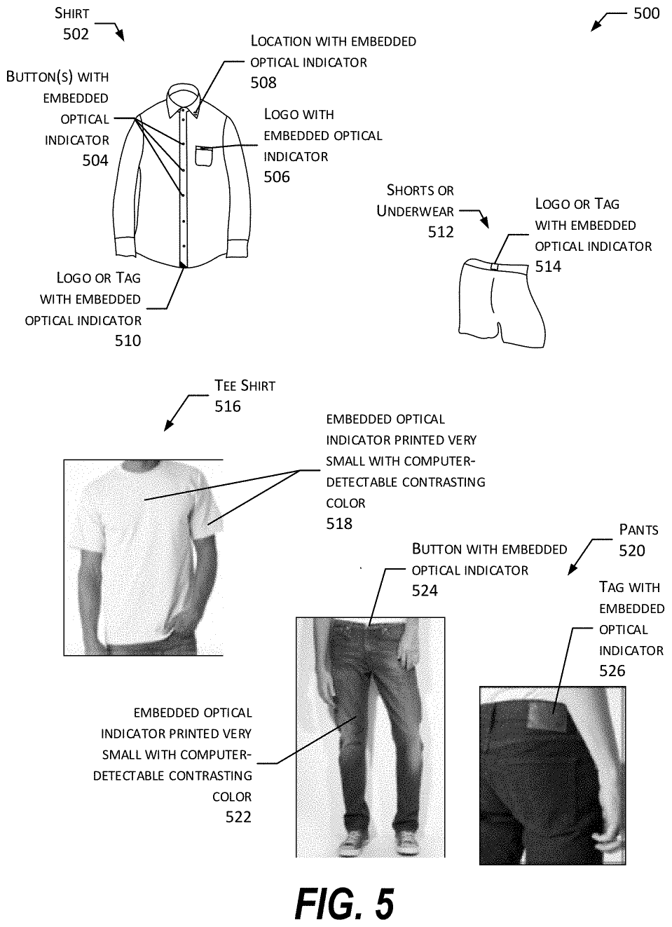

FIG. 5 depicts various products 500, each of which may include one or more optical indicators, in accordance with embodiments of the present disclosure. The products 500 may include a shirt 502, which may include a plurality of optical indicators. The shirt 502 may include buttons (or snaps) 504 with embedded optical indicators, a logo 506 with an embedded optical indicator, a location (or area) 508 on the shirt 502 with an embedded optical indicator, and a logo or tag 510 with an embedded optical indicator.

In one possible example, optical indicators may be placed on a product in predetermined locations or areas, making it possible for the computing device 104 or the one or more servers 110 to process one or more portions of the image data to determine the optical indicators. In another example, the optical indicator may include a woven pattern formed from woven, printed, or attached patterns, which may be too small or too subtle to be detected by a person of 20/20 vision, but which may be detected by the computing device 104 or the one or more servers 110 from the image data.

The products 500 may include a pair of shorts or underwear 512, which may include a logo or tag 514 with an embedded optical indicator. For example, the logo or tag 514 may include an embedded pattern (such as text, a barcode, a QR code, another pattern, or any combination thereof), which may be too small or too subtle to be detected by a person of 20/20 vision, but which may be detected by the computing device 104 or the one or more servers 110 from the image data.

The products 500 may include a tee shirt 516, which may include an embedded optical indicator 518, which may be printed very small with computer-detectable contrasting color. In an example, subtle contrasting white or near-white colors may be woven or printed in a pattern (small, subtle, or both) that may be difficult or impossible for a person of 20/20 vision to see but that may be detected by the computing device 104 or the one or more servers 110 from the image data.

The products 500 may include a pair of pants 520, such as a pair of jeans, which may include a button (or snap) 524 with an embedded optical indicator, a brand tag 526 with an embedded optical indicator, or a printed or woven optical indicator 522. The printed or woven optical indictor 522 may be printed very small with computer-detectable contrasting color on a pant leg or other area of the pants 520. In an example, the optical indicators may be very small or subtle, making it difficult or impossible for a person with 20/20 vision to see with the naked eye, but which may be detected by the computing device 104 or the one or more servers 110 from the image data.

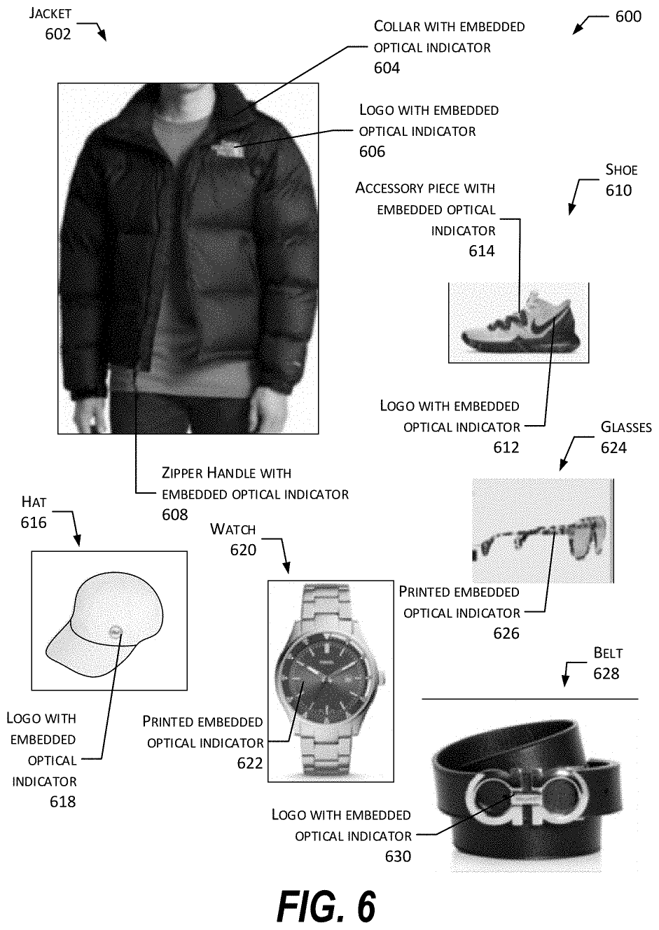

FIG. 6 depicts various products 600, each of which may include one or more optical indicators, in accordance with embodiments of the present disclosure. The products 600 may include a jacket 602, which may include a collar with an embedded optical indicator 604, a logo with an embedded optical indicator 606, and a zipper handle (or tag) with an embedded optical indicator 608.

The products 600 may include a shoe 610 including a logo with an embedded optical indicator 612. The shoe 610 may further include an accessory piece 614 with an embedded optical indicator. The accessory piece 614 may include a shoelace, a tag, or another element that includes the embedded optical indicator. Other implementations are also possible.

The products 600 may include a hat 616 including a logo with an embedded optical indicator 618. The products 600 can further include a watch 620 with a printed embedded optical indicator 622 on its face. The products 600 may also include glasses 624 with a printed embedded optical indicator 626 on the arm. The products 600 may further include a belt 628 including a logo with an embedded optical indicator 630 on the buckle or on another element of the belt.

The optical indicators may be woven, printed, attached, transferred onto, dye sublimated onto, or otherwise coupled to the products 600. As previously discussed, the optical indicators may be too small or too subtle to be detected by a person of 20/20 vision, but may be detected by the computing device 104 or the one or more servers 110 from the image data.

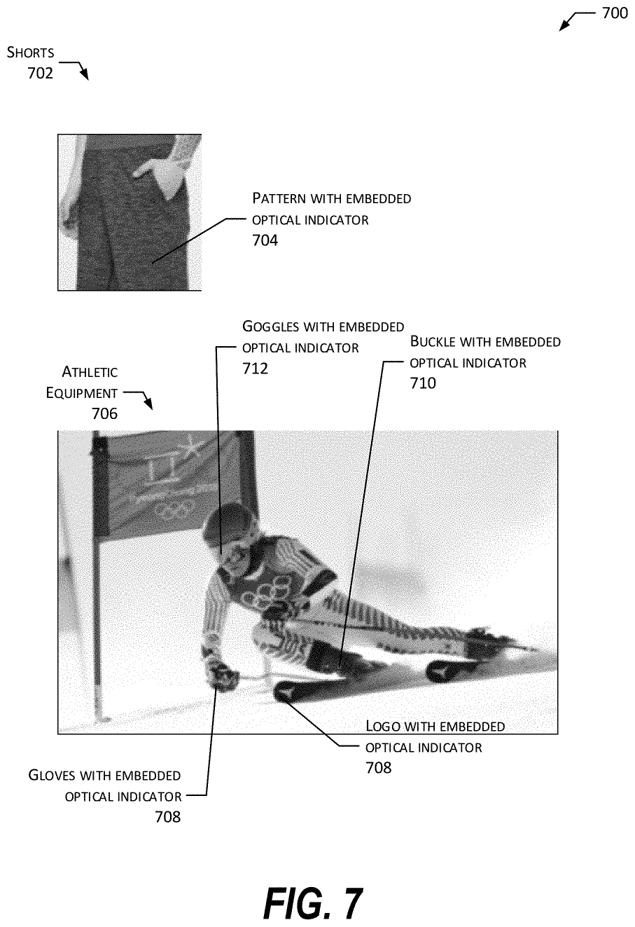

FIG. 7 depicts various products 700, each of which may include one or more optical indicators, in accordance with embodiments of the present disclosure. In this example, the products 700 may include a pair of shorts 702 with a pattern 704 including the embedded optical indicator. The pattern 704 may include barcode data, QR code data, text data, other data, or any combination thereof.

The products 700 may further include athletic equipment 706 including gloves 708 with an embedded optical indicator, skis including a logo 708 with an embedded optical indicator, a buckle 710 with an embedded optical indicator, and goggles 712 with an embedded optical indicator. In one possible example, the computing device 104 or the one or more servers 110 may receive the optical indicators and may provide information related to the product, information about the context of the image, information about an event, and so on. For example, with respect to the athletic equipment 706, the one or more servers 110 may provide information about a ski competition or another athletic event. In another example, the one or more servers 110 may provide information about services related to skiing, or travel to ski destinations, skiing lessons, other information, and so on. It should be appreciated that the one or more servers 110 may provide a wide variety of information. Other implementations are also possible.

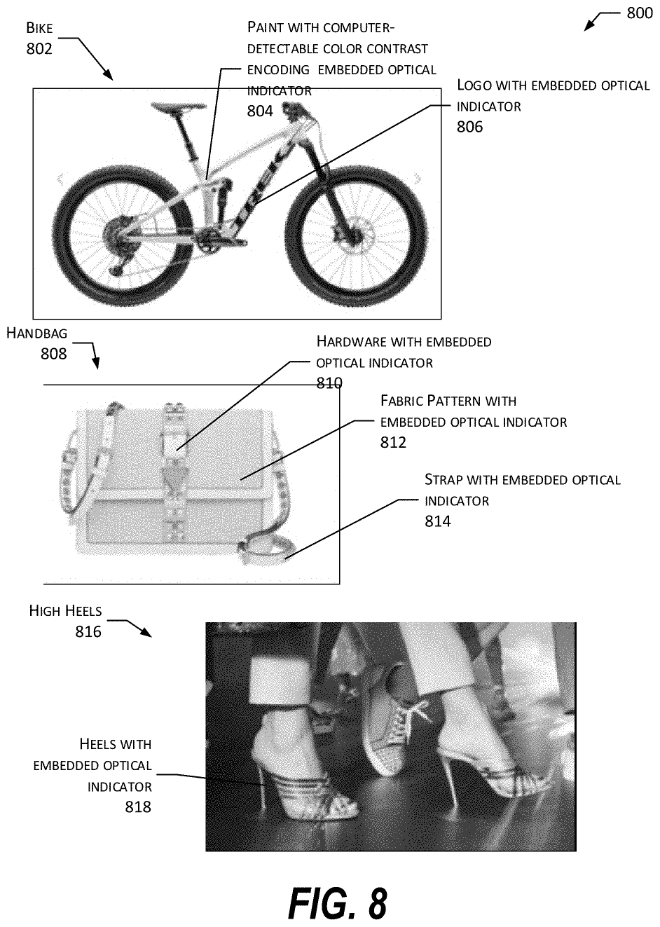

FIG. 8 depicts various products 800, each of which may include one or more optical elements, in accordance with embodiments of the present disclosure. The products 800 may include a bike 802 including paint 804 with computer-detectable color contrast encoding an embedded optical indicator. The bike 802 may include a logo 806 with an embedded optical indicator. The computer-detectable color contrast may encode text, a pattern (such as a barcode, a QR code, or other information), and so on.

The products 800 may further include a handbag 808 including hardware 810 (such a buckle, snap, or closure) with an embedded optical indicator, a fabric pattern 812 with an embedded optical indicator, and a strap 814 with an embedded optical indicator. The products 800 may include a pair of high heels 816, where the heels 818 include an embedded optical indicator. Other implementations are also possible.

It should be appreciated that, in some instances, the angle of the photo may mean that only a portion of an optical indicator is included in the image data. If multiple optical indicators are included on the product, the computing device 104 or the one or more servers 110 may be able to determine a complete optical indicator from portions of optical indicators recovered from different areas of the product.

In some implementations, optical indicators may be presented as a constellation or cluster of optical indicators on a particular portion of a product. Such a cluster or configuration may allow for optical detection regardless of the angle at which the image is captured. The computing device may be able to determine a sufficient number of such optical indicators to determine all of the information needed for the computing device 104 or the one or more servers 110 to identify the product or service or to determine further information.

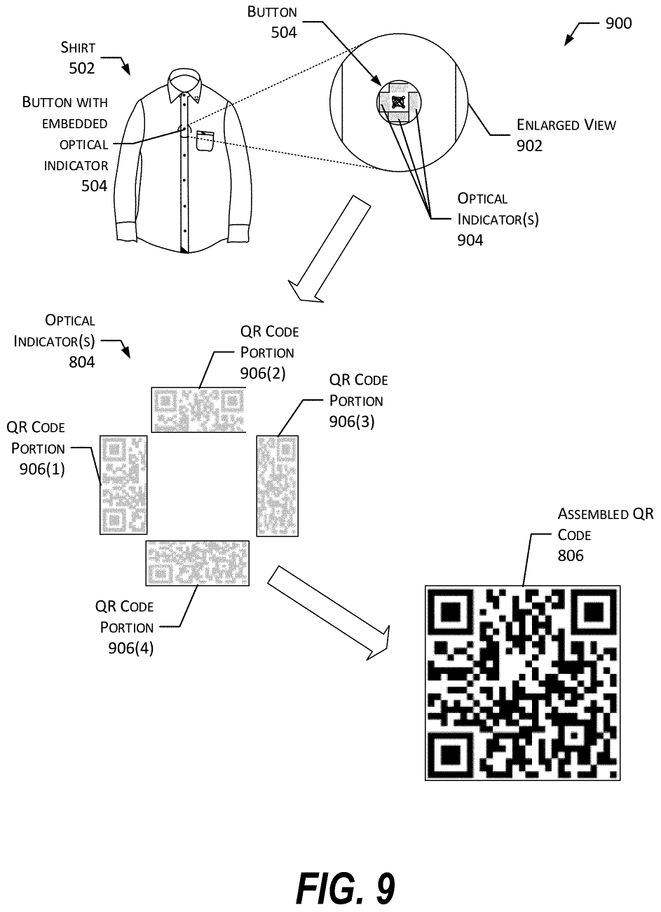

In the examples of FIGS. 5-8, the optical indicators may have a size attribute that is too small to be “read” or understood or seen with the unaided eye of a user 102 who has 20/20 vision. Alternatively (or in addition), the optical indicators may have a color contrast that is too subtle to be “read” or understood or seen with the unaided eye of a user 102 who has 20/20 vision. The computing device 104 or the one or more servers 110 may be able to determine information from the optical indicators. One possible example of an optical indicator is described below with respect to FIG. 9.

FIG. 9 depicts a diagram 900 showing one possible example of an optical indicator, in accordance with embodiments of the present disclosure. The diagram 900 depicts a shirt 502 with a button (or snap) 504 with an embedded optical indicator. The diagram 900 includes an enlarged view 902 of an area of the shirt 502 that includes the button (or snap) 504, with one or more embedded optical indicators 904. In this example, the embedded optical indicators 904 may include portions of a QR code 906. It should be appreciated that the QR code 906 in this example may be visible by close up inspection of the shirt 502, but the details of the QR code 906 may not be read without the aid of a computing device 104. Moreover, since the QR code 906 is divided into portions, the portions would need to be assembled before decoding. Further, any visible code on the button or snap 504 would look like decoration to a user 102, and thus would be “hidden” in plain sight.

In the illustrated example, the portions of the QR code 906 include a first QR code portion 906(1), a second QR code portion 906(2), a third QR code portion 906(3), and a fourth QR code portion 906(4). The first QR code portion 906(1) and the third QR code portion 906(3) or the second QR code portion 906(2) and the fourth QR code portion 906(4) may be combined to form the assembled QR code 806. Other implementations are also possible.

In some implementations, only partial QR code portions 906 may be visible, but the overlap between the first QR code portion 906(1) and the second QR code portion 906(2), for example, may be used to recover a missing portion. Similarly, the QR code portions 906 may be distributed across multiple buttons (or snaps) 504, across multiple areas, and so on. In one possible implementation, each of the optical indicators 904 may be the same, providing multiple redundancies. In another possible implementation, each assembled QR code 906 (or optical indicator) may include different information.

In another possible implementation, QR code portions 906(1), 906(2), 906(3), and 906(4) may be combined in different ways to present different information. In one configuration, the resulting assembled code may include product information. In another configuration, the resulting assembled code may include a URL with an identifying code that can be used to direct a computing device 104 or the one or more servers 110 to context information. Other data is also possible.

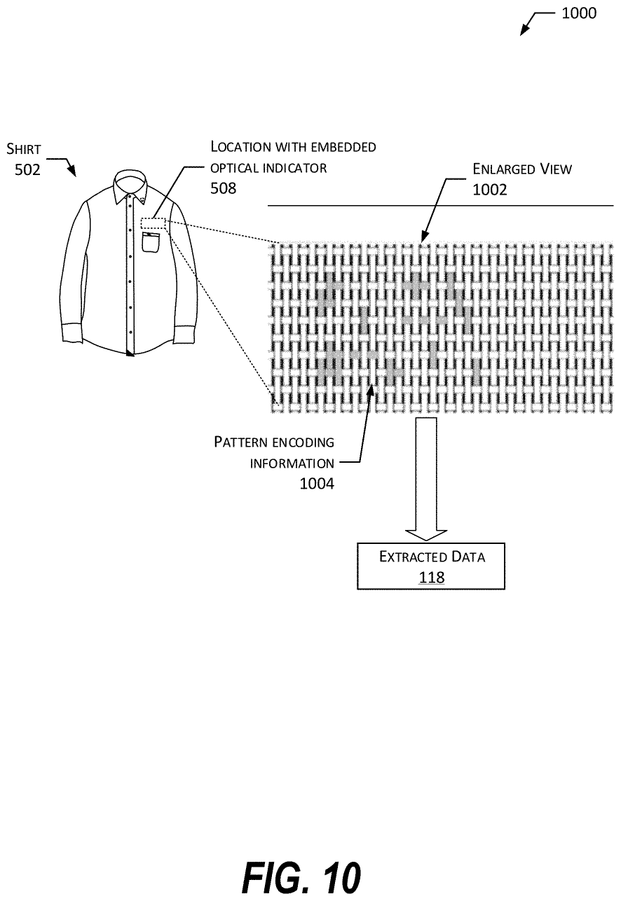

FIG. 10 depicts a diagram 1000 showing another possible example of an optical indicator, in accordance with embodiments of the present disclosure. The diagram 1000 includes a shirt 502 including a location 508 with an embedded optical indicator. An enlarged view 1002 of the location 508 may include a fabric weave including a pattern 1004 that encodes information. The pattern 1004 may be produced using subtle color contrasts, which may be difficult for a user 102 with 20/20 vision to see, but which may be detected by the computing device 104 or the one or more servers 110. Other implementations are also possible. The computing device 104 or the one or more servers 110 may be adapted to process image data associated with the location 508 on the shirt 502 to determine the optical indicator and to determine data from the optical indicator. The determined data may be extracted data 118, which can be used to determine further information about the shirt 502, such as its size, its color, its brand, and so on.

In the example of FIG. 10, the optical indicator may include a contrast attribute, that can be detected by a computing device 104, but which may be too subtle of a color variation to be detected by an average consumer. Moreover, the contrast attribute may include information that could not be read with the unaided eye of a user 102 with 20/20 vision. For example, a computer-readable pattern may be formed by subtle color contrasts, which pattern can be interpreted by a computing device 104 or the one or more servers 110. In a particular example, the pattern could include a barcode, a QR code, or other information.

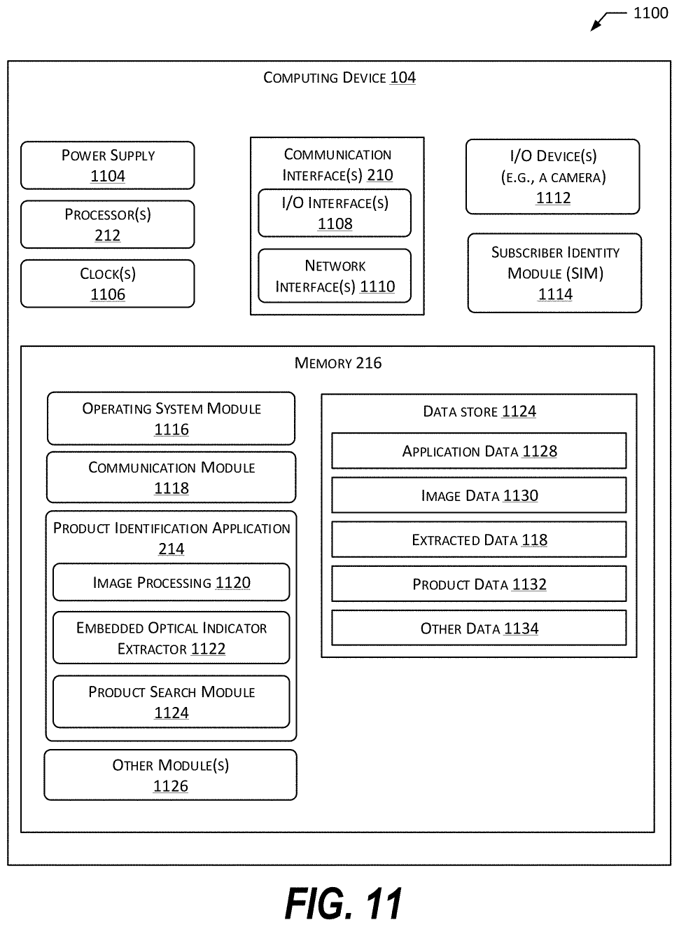

FIG. 11 depicts a block diagram 1100 of a computing device 104 that may be part of the systems of FIGS. 1 and 2, in accordance with embodiments of the present disclosure. The computing device 104 may be a smartphone, a laptop computer, a tablet computer, a desktop computer, or another computing device.

The computing device 104 may include a power supply 1104, which may supply power to the various components. The power supply 1104 may include a battery, power conversion circuitry, and various components to provide a stable voltage and current to the various components.

The computing device 104 may further include one or more processors 212 that may execute processor-readable instructions to perform various operations. The computing device 104 may further include one or more clocks 1106, which may provide timing signals. The one or more clocks 1106 may supply the timing signals to the one or more processors 212. Further, the one or more clocks 1106 may provide timing signals that may be used for time stamps and other timing operations.

The computing device 104 may further include one or more communications interfaces 210. The one or more communications interfaces 210 may include one or more input/output (I/O) interfaces 1108, which may communicate with one or more I/O devices 1112. The I/O interfaces 1108 may include wireless interfaces (such as Bluetooth, Zigbee, and the like) or wired interfaces (universal serial bus (USB), high definition media input (HDMI), other wired interfaces, or any combination thereof). The I/O devices 1112 may include input devices, such as keyboards, keypads, pointer devices, scanners, barcode readers, cameras, touch sensors, microphones, other input devices, or any combination thereof. The I/O devices 1112 may further include output devices, such as display devices, printers, speakers, other output devices, or any combination thereof. In some implementations, the I/O devices 1112 may include a touchscreen that provides display information and that can receive input data through the touch-sensitive interface. In one possible implementation, the I/O devices 1112 may include digital glasses, which may provide display data to a user 102.

The communications interface 210 may further include one or more network interfaces 1110. The one or more network interfaces 1110 may include one or more wireless transceivers such as short-range wireless communications (local area networks, Wi-Fi, Bluetooth, Zigbee, and so on), long-range wireless communications (cellular, digital, or satellite communications networks), and other wireless communications. The one or more network interfaces 1110 may also include wired communication interfaces, such as an RJ-45 Ethernet jack or other wired communication interfaces.

The computing device 104 may further include a subscriber identify module (SIM) 1114, which may identify the computing device 104 to a communications network. The SIM 1114 is an integrated circuit that stores an international subscriber identity number and its key, which are used to identify and authenticate subscribers on a mobile telephony network.

The computing device 104 may further include one or more memories 216. The memory 216 may include one or more operating system modules 1116, which may be executed to control operation of the computing device 104. The memory 216 may further include a communication module 1118, which may control operation of the communication interfaces 210.

The memory 216 may further include a product identification application 214, which may include an image processing module 1120 to determine one or more optical indicators within an image. The product identification application 214 may further include an embedded optical indicator extractor 1122, which may extract one or more optical indicators from the image. The product identification application 214 may further include a product search module 1124, which may utilize data extracted from the one or more optical indicators to search for information based on the extracted data. Other implementations are also possible.

The memory 216 may further include one or more other modules 1126. The one or more other modules 1126 may include various other applications that may be standard on the computing device 104.

The memory 216 may further include a data store 1124, which may store application data 1128. The data store 1124 may further include image data 1130, which may be captured by one of the I/O devices 1112 (such as a camera), or which may have been downloaded from a website or other source. The data store 1124 may further include extracted data 118, which may include data determined from one or more of the optical indicators. The data store 1124 may further include product data 1132, which may include information determined based on the data from the one or more optical indicators. The data store 1124 may further include other data 1124.

In some implementations, the computing device 104 may process the image data to determine the one or more optical indicators. In other implementations, the computing device 104 may send the image data to the one or more servers to determine the optical indicators. Other implementations are also possible.

In one possible implementation, a user 102 may utilize a computing device 104. The computing device 104 may be a pair of digital glasses. In another example, the computing device 104 may include a smartphone or other computing device and a pair of digital glasses in communication with the computing device 104. In this implementation, the digital glasses may capture image data and provide the image data to the one or more servers 110 through the network 106, either directly or through an intervening computing device 104, such as a smartphone. In this example, the digital glasses may capture image data of products or services that include optically detectable indicators that may be too small or too subtle to be detected by the naked eye of a user 102 having 20/20 vision. The digital glasses may receive response data 136 from the one or more servers 110 and may provide at least some of the response data to the display, providing an augmented reality experience for the user 102. Other implementations are also possible.

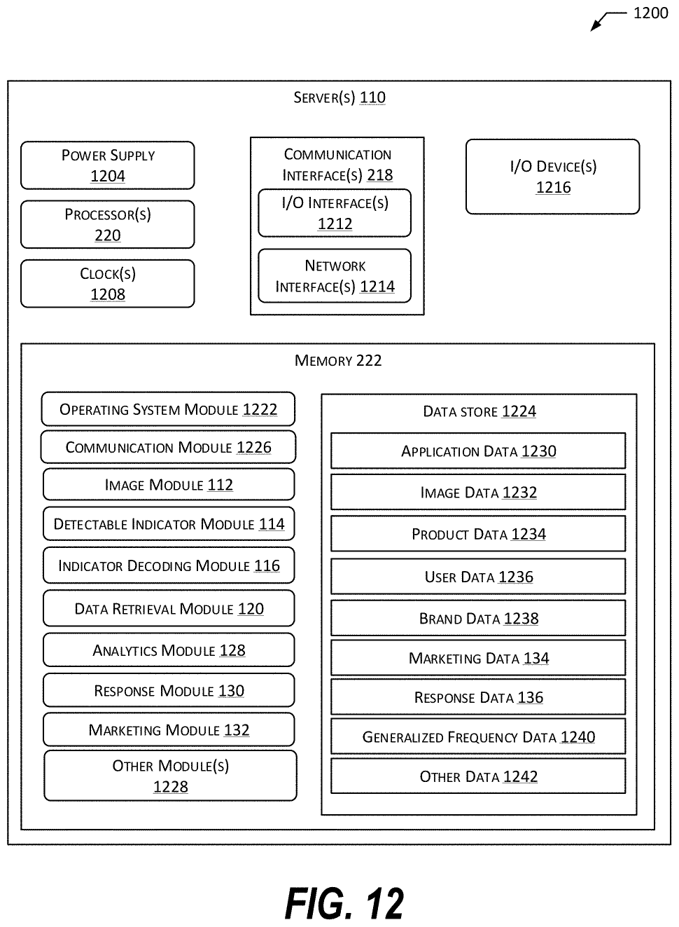

FIG. 12 depicts a diagram 1200 of the one or more servers 110 that may be part of the systems of FIGS. 1 and 2, in accordance with embodiments of the present disclosure. The server 110 may include a power supply 1204, which may supply power to the various components. The power supply 1204 may include a battery, power conversion circuitry, and various components to provide a stable voltage and current to the various components.

The server 110 may further include one or more processors 220 that may execute processor-readable instructions to perform various operations. The server 110 may further include one or more clocks 1208, which may provide timing signals. The one or more clocks 1208 may supply the timing signals to the one or more processors 220. Further, the one or more clocks 1208 may provide timing signals that may be used for time stamps and other timing operations.

The server 110 may further include one or more communications interfaces 218. The one or more communications interfaces 218 may include one or more input/output (I/O) interfaces 1212, which may communicate with one or more I/O devices 1216. The I/O interfaces 1212 may include wireless interfaces (such as Bluetooth, Zigbee, and the like) or wired interfaces (universal serial bus (USB), high definition media input (HDMI), other wired interfaces, or any combination thereof). The I/O devices 1216 may include input devices, such as keyboards, keypads, pointer devices, scanners, barcode readers, cameras, touch sensors, microphones, other input devices, or any combination thereof. The I/O devices 1216 may further include output devices, such as display devices, printers, speakers, other output devices, or any combination thereof. In some implementations, the I/O devices 1216 may include a touchscreen that provides display information and that can receive input data through the touch-sensitive interface.

The communications interface 218 may further include one or more network interfaces 1214. The one or more network interfaces 1214 may include one or more wireless transceivers such as short-range wireless communications (local area networks, Wi-Fi______33, Bluetooth, Zigbee, and so on), long-range wireless communications (cellular, digital, or satellite communications networks), and other wireless communications. The one or more network interfaces 1214 may also include wired communication interfaces, such as an RJ-45 Ethernet jack or other wired communication interfaces.

The computing device server 110 may further include one or more memories 222. The memory 222 may include one or more operating system modules 1222, which may be executed to control operation of the server 110. The memory 222 may further include a communication module 1226, which may control operation of the communication interfaces 218.

The memory 222 may further include an image module 112 to receive image data from a computing device 104. The memory 222 may further include a detectable indicator module 114, which may determine optical indicators within the image data. The memory 222 may further include an indicator decoding module 116, which may determine data from the optical indicators.

The memory 222 may also include a data retrieval module 120, which may be configured to retrieve information based on the determined data from the optical indicators. The data retrieval module 120 may send a query and may receive information in response to sending the query. The data retrieval module 120 may communicate with one or more data sources.

The memory 222 may also include an analytics module 128, which may determine information about the user based on the image data. In some implementations, the analytics module 128 may infer interests of the user 102 based on the current image data and optically based on historical image data. In an example, where the images contain similar types of information, such an inference may be based on the consistent content. Alternatively, where the images contain similar context information, the context may be used to infer an interest of a user 102. Such interests may include, but are not limited to, athletic events, outdoor interests, family, and so on. A wide variety of user interests can be reliably inferred.

The memory 222 may further include a response module 130 that may send response data 126 to the computing device 104. The response module 130 may format information and include additional information. Further, the memory 222 may include a marketing module 132 that may determine marketing information from one or more data sources and may provide the marketing information to the response module 130, which may include the marketing information in the response data 126. In one possible example, the analytics module 128 may provide the inferred interest information to the marketing module 132 to enable targeted marketing to the interests of the user 102. Other implementations are also possible. The memory 222 may further include other modules 1228.

The memory 222 may further include a data store 1224, which may store application data 1230, such as data determined from received image data. For example, the received image data may be sent by a computing device 104, which may provide identifying information that can be used to determine the computing device 104 and information about the user. The application data 1230 may include user account information.

The data store 1224 may include image data 1232, such as the image data received from the computing device 104. The data store 1224 may also include product data 1234, which may include data determined from one or more optical indicators as well as information determined based on the data. The data store 1224 may further include user data 1236, which may include historical information about products that the user 102 searched, information entered by the user 102 to establish an account, information inferred about interests of the user 102, other information, or any combination thereof.

The data store 1224 may include brand data 1238 determined based on the optical indicators. The data store 1224 may also include marketing data 134, which may be used by the marketing module 132. In one possible example, the marketing data 134 may include a list of data sources from which marketing information and instructions may be retrieved. The data store 1224 may further store the response data 136 that is provided to the computing device 104. Other implementations are also possible.

In some implementations, the data store 1224 may include generalized frequency data 1240, which may be determined by the analytics module 128. The generalized frequency data 1240 may include information about the usage of the user 102, which may be indicative of the user's emotional connection to the application, to the products, to the service, to the context of the products or service, to other interests, or any combination thereof. The emotional connection may be invaluable for marketing purposes, in part, because the marketing may be targeted to the emotional connection of the user 102. Such targeted marketing may be highly effective in terms of getting users to consider certain brands, pushing certain products, and so on.

In some implementations, the data store 1224 may store other data 1242. Such other data 1242 may include information about various parameters. Other implementations are also possible.

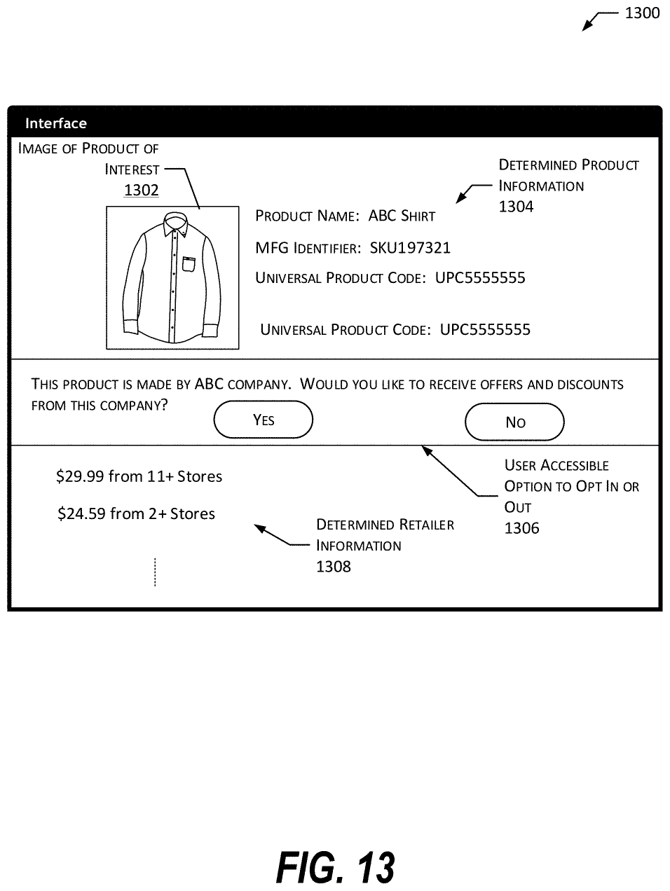

FIG. 13 depicts a diagram of a graphical interface 1300 that may be displayed on a computing device, in accordance with embodiments of the present disclosure. In some implementations, the graphical interface 1300 may be provided to a display of the computing device 104. In an example, the graphical interface 1300 may be an example of response data 126, which may be provided to the computing device 104 from the one or more servers 110. The graphical interface 1300 may include an image of a product of interest 1302, determined product information 1304, an option 1306 to opt in or out of future communications (and offers, such as price discounts, educational offers, and the like) from the company, and determined retailer information 1308.

In the illustrated example, the determined retailer information 1308 may include one or more retailers from which the particular product of interest may be purchased. In this example, the shirt may be available for $29.99 from eleven or more stores, or for $24.99 from two or more stores. In another implementation, the determined retailer information 1308 may include a nearest retailer to the computing device 104 of the user 102. In yet another implementation, the determined retailer information 1308 may include an indication of which retailer may deliver the product fastest, and so on. In another possible example, the system may provide information about a service, an event, a competing product, a complementary product, a brand, a competitor, other information, or any combination thereof. Other implementations are also possible.

It should be appreciated that the graphical interface 1300 represents one possible implementation of response data 126, which may be provided to the computing device 104. Other implementations are also possible.

For example, in one implementation, the response data 126 including the graphical interface 1300 may provide information that is not directly related to the product. In one possible example, the graphical interface 1300 may display information about an event, information about other products, information about complementary products, information about competitive products, information about the context of the image, other information, or any combination thereof.

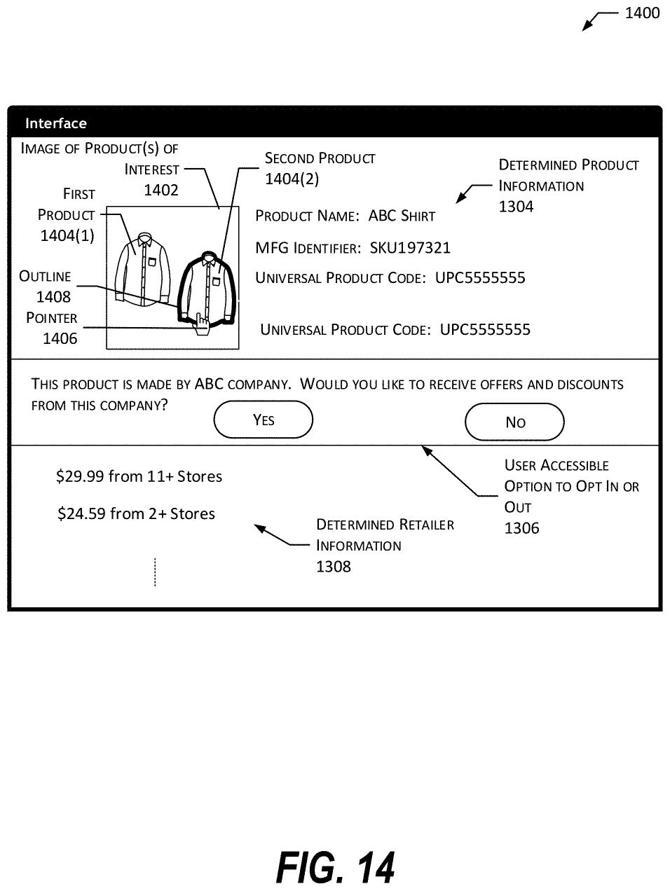

In some implementations, the image data may include multiple possible products or services of interest. For example, an image of a technician working on a bicycle in a bicycle repair shop may include one or more first optical indicators associated with the bicycle, one or more second optical indicators associated with the repair technician, one or more third optical indicators associated with the bicycle repair shop, and one or more fourth optical indicators associated with one or more other objects or services within the image data. The graphical interface 1300 may display information related to the one or more first optical indicators but may a user-selectable option to view data associated with others of the optical indicators. One possible example is described below with respect to FIG. 14.

FIG. 14 depicts a diagram of a graphical interface 1400 that may be displayed on a computing device 104, in accordance with embodiments of the present disclosure. In this simplified example, the image data may include a first product 1404(1) and a second product 1404(2). Though only two products 1404 are shown, it should be appreciated that the image data may include a plurality of products 1404, may include optical indicators related to services, or any combination thereof.

In this example, the graphical interface 1400 may depicts the image data and may display default information about the first product 1404(1). The user 102 may interact with the computing device 104, such as by touching the touchscreen display with his or her finger or using a pointer device (such as a stylus or mouse) to move a pointer 1406 over the second product 1404(2). As the pointer 1406 is moved over an identified product 1404, an outline 1408 may appear, which may notify the user 102 that there is available information about that product 1404(2). Alternatively, the outline may surround other products 1404, an area indictive of a service offering, and so on.

It should be appreciated that the graphical interfaces 1300 and 1400 of FIGS. 13 and 14 are illustrative examples only and are not intended to be limiting. The image data and information may be displayed in other graphical interfaces with different arrangements of data without departing from the scope of the disclosure.

For example, in an implementation involving digital glasses providing an augmented reality experience for the user 102, objects within a field of view of the user 102 may be identified based on optical indicators and may be highlighted, shaded, or otherwise optically modified within the field of view of the user 102 to indicate there is further information available. The user 102 may then interact with the digital glasses or an associated computing device 104 to access the information. In this example, the information may be presented as an overlay on the product, in a popup window, audibly, or any combination thereof. Other implementations are also possible.

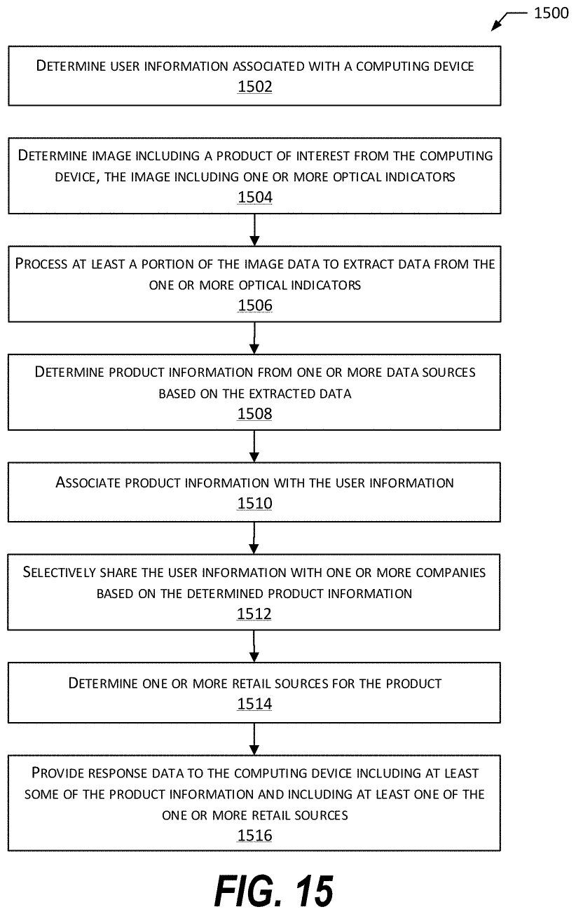

FIG. 15 depicts a flow diagram 1500 of a method of determining information based on optical indicators, in accordance with embodiments of the present disclosure. At 1502, user information is determined that is associated with a computing device 104. The user information may include a unique identifier associated with the application, username and password information associated with the user, or another identifier that can uniquely identify an account associated with the user. Other implementations are also possible.

At 1504, an image that includes a product of interest is determined from the computing device 104, where the image includes one or more optical indicators. In an example, the image may be captured by a camera of the computing device 104 and sent to the one or more servers 110 for analysis. In another example, the image may be downloaded using the computing device 104 and sent to the one or more servers 110. Other implementations are also possible.

At 1506, at least a portion of the image data is processed to extract data from the one or more indicators. The data may be extracted by determining color contrast variations that are greater than a threshold difference and that may include information, such as text, a pattern (barcode, QR code, etc.), or other information. In one possible example, a product may include one or more optical indicators, but only a portion of one of the indicators may be visible. In this example, the portion of the optical indicator may include a link, which can be used by the system to determine additional information.

At 1508, product information is determined from one or more data sources based on the extracted data. The product information may be determined by searching one or more data sources. The data sources may include databases, websites, retailer sites, and so on.

At 1510, the production information is associated with the user information. In an example, a user account associated with the user 102 may be updated with product information, information determined from the image (such as context information), other information, or any combination thereof. Over time, as a user submits more images to the system, the analytics module 128 may determine interests of the user 102.

At 1512, the user information may be selectively shared with a source of the product based on the determined product information. Alternatively, the user information may be shared with the source of a competitive product or a complementary product. Alternatively, the user information may be shared with a service that is related to the product or may be shared with sources of products or services that have nothing to do with the product. In one possible example, the user information may be shared with a particular retailer, manufacturer, or service based on an inferred interest of the user 102. For example, the one or more servers 110 may determine a source of a product and may share the user information with the source to allow the source to provide a targeted offer to the user 102. Other implementations are also possible.

At 1514, one or more retail sources for the product may be determined. For example, the one or more servers 110 may use the extracted data to determine the product identifier. The one or more servers 110 may search one or more data sources to determine retailers from which the product may be purchased. Alternatively, the one or more servers 110 may search one or more other data sources, such as websites that allow users to resell items. Further, the one or more servers 110 may determine information from various sources, including websites, review sites, other data sources, or any combination thereof. Further, the one or more servers 110 may determine information from a pre-indexed database. Other implementations are also possible.

At 1516, response data may be provided to the computing device 104, where the response data 136 may include at least some of the product information and at least one of the one or more retail sources. In an example, the response data 136 may include an image of the product as well as information about the product and options to purchase the product. Other implementations are also possible.

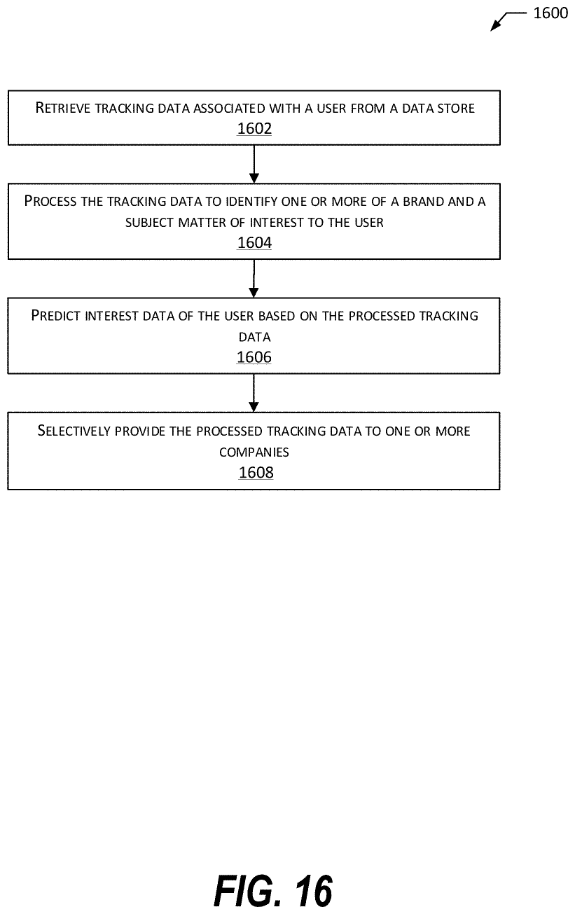

FIG. 16 depicts a flow diagram of a method 1600 of providing information based on optical indicators, in accordance with embodiments of the present disclosure. At 1602, tracking data associated with a user may be retrieved from a data store. For example, an application associated with a computing device of a user may access a server to retrieve information about a product based on one or more optical indicators. The user may be identified by a server, for example, based on login information, a unique identifier of the application, other data, or any combination thereof. The server may retrieve the tracking data based on the identification. In some instances, the tracking data may include historical search data corresponding to prior usage of the application by this user.

At 1604, the tracking data may be processed to identify one or more of a brand and a subject matter of interest to the user. For example, the tracking data may reveal that the user has consistently looked at products of a particular brand. In this case, the system may surface brand information. In one possible example, the system may suggest that if the user 102 likes Brand X, the user will also probably like Brand Y. In another example, the tracking data may reveal that the user has consistently looked at products of a particular type, such as a collared dress shirt. In yet another example, the tracking data may reveal that the user has consistently looked at products in a particular context, such as outdoor family activities. Other implementations are possible as well.

At 1606, interest data of the user may be predicted based on the processed tracking data. In the above-examples of a particular brand or a collared shirt, the interest of the user may be relatively easy to predict. In other instances, the tracking data may be more varied, and the processed tracking may reveal more diverse interests. For example, the system may take into account not only the product(s) in the image data but the context surrounding the product(s). The system may infer information about what connects the particular consumer to the product emotionally based on the context information. The more instances of a user 102 connecting to products or services with context information readily available enhance the learning of the analytics module 128 of the one or more servers 110. Over time, the analytics module 128 may become more accurate in predicting an emotional connection between the user 102 and a particular product. For example, if a consumer repeatedly seeks to know more about products featured in images of a happy family vacation, it may be assumed that family and doing things together as a family may be important to the consumer. As the system receives more images from the device of the user, the system may determine more “context” for the user, and determine one or more deductions regarding what connects the user emotionally to products or services. Thus, the system may predict data of interest to the user based on the processed tracking data, and may suggest such products, services, experiences, or data of interest to the user 102.

At 1608, processed tracking data may be selectively provided to one or more companies. Alternatively, or in addition, the processed tracking data may be provided to marketing companies, or to one or more other companies that are likely to have an interest in the user 102. The interest in the user 102 may include selling the exact product, a similar product, a complementary product, or a competitive product to the user 102. The interest in the user 102 may include buying a similar product from the user 102, or interesting the user in a related service, a brand, a related product, and so on. For example, the processed tracking data may be provided as inferred interest to one or more suppliers, companies, and organizations that could have an interest in the user. Other implementations are also possible.

In conjunction with the systems, methods, devices, and graphical interfaces described above with respect to FIGS. 1-16, a system is disclosed in which image data is processed to determine one or more optical indicators associated with a product or a service. In the event that the system does not determine one or more optical indicators, the system may provide response data 136 that indicates that the product or service cannot be identified from the image. In one possible implementation, the response data 136 may prompt the user 102 to provide additional images if possible. If the system detects an optical indicator, the system may extract data from the optical indicators, determine information based on the optical indicators, and provide the determined information as response data 136 to the computing device 104 of a user 102.

In some implementations, the response data 136 may include information about the product, information about one or more complementary products, information about one or more competitive products, direct comparisons with competitive products, information about the brand, information about the context of the image, information about a service, information about a location, other information, or any combination thereof. Further, in some implementations, the response data 136 may include information of interest to the user, such as event information, activity information, family-related activities, other items of interest, related services that may be of interest, or any combination thereof.

Implementations that may be used within the scope of the present disclosure may be illustrated by way of the following clauses:

In one implementation, a system may receive an image, determine data from one or more optically detectable indicators within the image, retrieve further information based on the determined data, and provide an output including response data. The response data may include product information related to one or more products within the image, information about a person within the image, information about complementary products, information about competing products, information about services, information about events, information about activities, and so on. Such information may be determined based on the one or more optically detectable indicators within the image.

Clause 1. A system comprises an interface to communicate with a communications network; a processor; and a memory storing data including image data and storing processor-readable instructions that cause the processor to receive data including one or more images; and determine at least a portion of a first product within one of the one or more images. The portion of the first product may include one or more optically detectable indicators including data about one or more of the product, a competing product, a complementary product, a service, and an event. Each of the one or more optically detectable indicators may have one of a size attribute and a contrast attribute that renders the optical indicator invisible to a consumer's unaided sight. The instructions may cause the processor to determine data from at least one of the one or more optically detectable indicators, retrieve information related to the product based on the determined data from one or more data sources via a network, and provide an output including response data including information related to the product.
Clause 2: The system of clause 1 wherein the one or more images may be received from a computing device through the communications network and the output is provided to the computing device through the communications network.
Clause 3: The system of any of the preceding clauses further comprises a data repository including a database of consumers. The database of consumers may include a plurality of consumer identifiers and associated product information. The plurality of consumer identifiers may include a first identifier associated with a first consumer and first product information corresponding to information about products previously provided to the first consumer. The instructions may cause the processor to determine the first identifier from the received data, retrieve the first product information from the database, and process the first product information to determine one or more attributes of the first consumer.
Clause 4: The system of any of the preceding clauses where the instructions cause the processor to provide the one or more attributes of the first consumer to one or more product vendors, receive one or more of product offers, product information, and brand information from the one or more product vendors, and include the one or more product offers within the output.
Clause 5. The system of any of the preceding clauses where the instructions may cause the processor to provide the one or more attributes of the first consumer to an analytics module, determine one or more interests of the first consumer based on the one or more attributes using the analytics module, and provide information related to the one or more interests of the consumer within the output.
Clause 6. The system of any of the preceding clauses where the instructions may cause the processor to determine one or more products the first consumer based on the one or more attributes, search one or more data sources to retrieve available product data corresponding to the one or more products of interest, and include the available product data within the output.
Clause 7. The system of any of the preceding claims further comprises a camera coupled to the processor and a display coupled to the processor. The image is received from the camera and the output is provided to the display.
Clause 8: The system of any of the preceding clauses, further comprises a camera coupled to the processor and a display coupled to the processor. The image is received from the camera and the output includes one of a uniform resource locator (URL) and a web page.
Clause 9: The system of any of the preceding clauses where the instructions cause the processor to determine a portion of the product within the image; determine a subset of image values within the determined portion; and determine a first indicator of the one or more optically detectable indicators within the subset of image values.
Clause 10: The system of any of the preceding clauses where the instructions cause the processor to determine the image includes no optically detectable indicators, provide the response data including an indication that the image did not include information, and a request for additional images.
Clause 11: The system of any of the preceding clauses where the instructions may cause the processor to determine a location on the product within the image. The location may include an optically detectable indicator. The instructions may cause the processor to determine contrast values within the location on the product. The contrast values define a pattern encoding data. The instructions may cause the processor to decode the pattern to determine the data about the product.
Clause 12: The system of any of the preceding clauses where a first indicator of the one or more optically detectable indicators comprises an object including one of a button, a snap, a fastener, a handle, and a logo. The object may include a pattern defined by one or more of a shape of the object, one or more shapes included within the object, one or more colors included within the object, one or more colors printed on the object, and one or more etches formed in a surface of the object. The pattern includes information about the product.
Clause 13: The system of any of the preceding clauses where a first optically detectable indicator of the one or more optically detectable indicators comprises a logo including a pattern defined by one or more of one or more shapes embedded in the logo, one or more shapes define the pattern, one or more colors embedded in the logo. The one or more colors may provide detectable contrast patterns defining the pattern, wherein the pattern encodes information about the product.
Clause 14: The system of any of the preceding clauses where a first product of the one or more products includes a logo. The logo may include a first indicator and a second indicator of the one or more optically detectable indicators. The first indicator includes first information related to the first product. The first information may include at least one of product identifying data, product brand data, product vendor data, and product coupon data. The second indicator may include second information related to one or more complementary products.
Clause 15: The system of any of the preceding clauses where at least one of the one or more optically detectable indicators includes one or more of coupon data and discount data.
Clause 16: The system of any of the preceding clauses where the instructions cause the processor to populate a portion of a warranty registration form based on at least one of the one or more optically detectable indicators, provide the warranty registration form including the populated portion to a computing device, receive input data corresponding to the warranty registration form from the computing device, and register the warranty in response to receiving the input data.
Clause 17: The system of any of the preceding clauses where the one or more optically detectable indicators may include a first indicator and a second indicator. The instructions cause the processor to determine first data from the first indicator. The first data may include at least a first portion of a pattern encoding data about the product. The instructions may cause the processor to determine second data from the second indicator. The second data may include at least a second portion of the pattern encoding data about the product. The instructions may further cause the processor to determine the pattern by combining the first portion and the second portion and determine the data about the product based on the determined pattern.
Clause 18: The system of any of the preceding clauses where the one or more images may include a sequence of images of the first product. The instructions may cause the processor to determine a plurality of optically detectable indicators from the sequence of images and determine a discount code when a count of the plurality of detectable indicators exceeds a count threshold.
Clause 19: The system of any of the preceding clauses may comprise instructions that may cause the processor to determine marketing data corresponding to the product information. The response data may include a user-selectable option accessible by a user to elect to receive marketing information from a company related to one or more of the product, a complementary product, a competing product, a related service, a related event, and other information.
Clause 20: The system of any of the preceding clauses may comprise instructions that cause the processor to receive one or more images from a user device associated with a user through the communications network, determine one or more attributes of the user based on the one or more images, determine recommended product information from one or more data sources based on the determined one or more attributes, and send the recommended product information to the user device.
Clause 21: A method comprises receiving an image at a processor of a computing system. The image may include a product including a plurality of optically detectable indicators. The method may further include determining one or more indicators of the plurality of optically detectable indicators from the image using the processor, determining encoded data from the one or more indicators using the processor, retrieving product data from one or more data sources based on the encoded data, and providing response data including first information about the product based on the retrieved product data and including second information. The second information including other information determined to be of interest to a consumer.
Clause 22: The method of any of the preceding clauses further comprises capturing the image using a camera of the computing device, and providing the response data to a display device.
Clause 23. The method of any of the preceding clauses further comprises processing one or more portions of the image corresponding to the product to determine a first indicator of the one or more indicators, and determine a pattern associated with the first indicator. The pattern may encode data associated with the product. The method may include decoding the pattern to determine the encoded data.
Clause 24: The method of any of the preceding clauses may further comprise determining a first indicator and a second indicator of the one or more indicators, determining a first portion of a pattern encoded in the first indicator, determining a second portion of the pattern encoded in the second indicator, and combining the first portion and the second portion to determine the pattern.
Clause 25: The method of any of the preceding clauses may further comprise receiving one or more images from a user device; determining one or more attributes of a user based on the one or more images, determining marketing data corresponding to the one or more attributes, and providing one or more of product information, event information, brand information, and other information to the user device based on the marketing data.
Clause 26. A system may comprise an interface to communicate with a computing device of a consumer through a communications network, a processor, and a memory storing data including image data and storing processor-readable instructions. The instructions cause the processor to receive an image from the computing device and determine a product within the image. The product may include one or more optically detectable indicators. Each optically detectable indicator includes encoded data. The instructions may cause the processor to determine a first indicator and a second indicator from the one or more optically detectable indicators, determine first encoded data from the first indicator and second encoded data from the second indicator, determine the encoded data about the product from one or more of the first encoded data and the second encoded data, retrieve information about one or more of the product, related products, and complementary products from one or more data sources based on the encoded data via the communication network, and provide response data including the retrieved information to the computing device.
Clause 27: The system of any of the preceding clauses includes instructions that cause the processor to determine a first context surrounding the product, determine one or more second contexts surrounding other products previously communicated to the computing device of the consumer, and determine one or more emotional attributes of the consumer based on the first context and the one or more second contexts.
Clause 28: The system of any of the preceding clauses includes instructions that cause the processor to determine information of interest to the consumer based on the one or more emotional attributes.
Clause 29: The system of any of the preceding clauses includes instructions that cause the processor to determine a first portion of the product within the image, determine a first subset of image values within the first portion of the product within the image, and determine the first indicator within the first subset of image values based on optically detectable contrast, the first indicator defining at least a first portion of a pattern encoding product data, determine a second portion of the product within the image, determine a second subset of image values within the second portion of the product within the image, and determine the second indicator within the second subset of image values based on optically detectable contrast. The second indicator may define at least a second portion of the pattern encoding the product data.

Although the present invention has been described with reference to preferred embodiments, workers skilled in the art will recognize that changes may be made in form and detail without departing from the scope of the invention.

What is claimed is:

1. A system comprising:
an interface to communicate with a communications network;
a processor; and
a memory storing data including image data and storing processor-readable instructions that cause the processor to:
receive data including one or more images;
determine at least a portion of a first product within one of the one or more images, the portion of the first product including one or more optically detectable indicators including data about one or more of the product, a competing product, a complementary product, a service, and an event, each of the one or more optically detectable indicators having one of a size attribute and a contrast attribute that renders the optical indicator invisible to a consumer's unaided sight;
determine data from at least one of the one or more optically detectable indicators;
retrieve, via the communication network, information related to the product from one or more data sources based on the determined data; and
provide an output including response data including information related to the product, the response data including one or more of product information.

2. The system of claim 1, wherein:
the one or more images is received from a computing device through the communications network; and
the output is provided to the computing device through the communications network.

3. The system of claim 1, further comprising:
a data repository including a database of consumers, the database including a plurality of consumer identifiers and including associated product information, the plurality of consumer identifiers including a first identifier associated with a first consumer and including first product information corresponding to information about products previously provided to the first consumer; and
the processor-readable instructions that cause the processor to:
determine the first identifier from the received data;
retrieve the first product information from the database; and
process the first product information to determine one or more attributes of the first consumer.

4. The system of claim 3, the instructions cause the processor to:
provide the one or more attributes of the first consumer to one or more product vendors;
receive one or more of product offers, product information, and brand information from the one or more product vendors; and
include the one or more product offers within the output.

5. The system of claim 3, the instructions cause the processor to:
provide the one or more attributes of the first consumer to an analytics module;
determine, using the analytics module, one or more interests of the first consumer based on the one or more attributes; and
provide information related to the one or more interests of the consumer within the output.

6. The system of claim 3, the instructions cause the processor to:
determine one or more products the first consumer based on the one or more attributes;
search one or more data sources to retrieve available product data corresponding to the one or more products of interest; and
include the available product data within the output.

7. The system of claim 1, further comprising:
a camera coupled to the processor;
a display device coupled to the processor; and
wherein:
the image is received from the camera; and
the output is provided to the display device.

8. The system of claim 1, the instructions cause the processor to:
determine a portion of the product within the image;
determine a subset of image values within the determined portion; and
determine a first indicator of the one or more optically detectable indicators within the subset of image values.

9. The system of claim 1, the instructions cause the processor to:
determine a location on the product within the image, the location including an optically detectable indicator;
determine contrast values within the location on the product, the contrast values defining a pattern encoding data that represents a first optical indicator; and
decode the pattern to determine the data about the product.

10. The system of claim 1, wherein at least one of the one or more optically detectable indicators includes one or more of coupon data and discount data.

11. The system of claim 1, wherein a first indicator of the one or more optically detectable indicators comprises an object including one of a button, a snap, a fastener, a handle, and a logo, the object including a pattern defined by one or more of:
a shape of the object;
one or more shapes associated with the object;
one or more colors included within the object;
one or more colors printed on the object; and
one or more etches formed in a surface of the object;
wherein the pattern includes information about the product.

12. The system of claim 1, wherein:
a first product of the one or more products includes a logo;
the logo includes a first indicator and a second indicator of the one or more optically detectable indicators;
the first indicator includes first information related to the first product, the first information including at least one of product identifying data, product brand data, product vendor data, and product coupon data;
the second indicator includes second information related to one or more complementary products.

13. The system of claim 1, the processor-readable instructions cause the processor to:
populate a portion of a warranty registration form based on at least one of the one or more optically detectable indicators;
provide the warranty registration form including the populated portion to a computing device;
receive input data corresponding to the warranty registration form from the computing device; and
register the warranty in response to receiving the input data.

14. The system of claim 1, wherein the one or more optically detectable indicators includes a first indicator and a second indicator; and
the processor-readable instructions cause the processor to:
determine first data from the first indicator, the first data including at least a first portion of a pattern encoding data about the product;
determine second data from the second indicator, the second data including at least a second portion of the pattern encoding data about the product;
determine the pattern by combining the first portion and the second portion;
determine the data about the product based on the determined pattern.

15. The system of claim 1, wherein the one or more images include a sequence of images of the first product; and
the processor-readable instructions cause the processor to:
determine a plurality of optically detectable indicators from the sequence of images; and
determine a discount code when a count of the plurality of detectable indicators associated with a particular product exceeds a count threshold.

16. A method comprising:
receiving an image at a processor of a computing system, the image including a product, the product including a plurality of optically detectable indicators;
determining one or more indicators of the plurality of optically detectable indicators from the image using the processor;
determining encoded data from the one or more indicators using the processor;
retrieving product data from one or more data sources based on the encoded data;
providing response data including first information about the product based on the retrieved product data and including second information, the second information including other information determined to be of interest to a consumer.

17. The method of claim 16, further comprising:
processing one or more portions of the image corresponding to the product to determine a first indicator of the one or more indicators;
determine a pattern associated with the first indicator, the pattern encoding data associated with the product; and
decode the pattern to determine the encoded data.

18. The method of claim 16, further comprising:
determining a first indicator and a second indicator of the one or more indicators;
determining a first portion of a pattern encoded in the first indicator;
determining a second portion of the pattern encoded in the second indicator;
combining the first portion and the second portion to determine the pattern.

19. The method of claim 16, further comprising:
receiving one or more images from a user device;
determining one or more attributes of a user based on the one or more images;
determining marketing data corresponding to the one or more attributes; and
providing one or more of product information, event information, brand information, and other information to the user device based on the marketing data.

20. A system comprising:
an interface to communicate with a computing device of a consumer through a communications network;
a processor; and
a memory storing data including image data and storing processor-readable instructions that cause the processor to:
receive an image from the computing device;
determine a product within the image, the product including one or more optically detectable indicators, each optically detectable indicator including encoded data;
determine a first indicator and a second indicator from the one or more optically detectable indicators;
determine first encoded data from the first indicator and second encoded data from the second indicator;
determine the encoded data about the product from one or more of the first encoded data and the second encoded data;
retrieve, via the communication network, information about one or more of the product, related products, and complementary products from one or more data sources based on the encoded data; and
provide response data including the retrieved information to the computing device.

21. The system of claim 20, the processor-readable instructions cause the processor to:
determine a first context surrounding the product;
determine one or more second contexts surrounding other products previously communicated to the computing device of the consumer;
determine one or more emotional attributes of the consumer based on the first context and the one or more second contexts.

22. The system of claim 21, the processor-readable instructions cause the processor to determine information of interest to the consumer based on the one or more emotional attributes.

23. The system of claim 20, the processor-readable instructions cause the processor to:
determine a first portion of the product within the image;
determine a first subset of image values within the first portion of the product within the image; and
determine the first indicator within the first subset of image values based on optically detectable contrast, the first indicator defining at least a first portion of a pattern encoding product data;
determine a second portion of the product within the image;
determine a second subset of image values within the second portion of the product within the image;
determine the second indicator within the second subset of image values based on optically detectable contrast, the second indicator defining at least a second portion of the pattern encoding the product data.
